(19) United States
(12) Patent Application Publication
(10) Pub. No.: US 2016/0225009 A1
(43) Pub. Date: Aug. 4, 2016

(54) PERMITTING A BUSINESS WITH PHYSICAL LOCATIONS TO CONNECT WITH THEIR CUSTOMERS ON THEIR MOBILE DEVICES (RETAP)

(71) Applicant: Yext, Inc., New York, NY (US)

(72) Inventors: Howard C. Lerman, New York, NY (US); Thomas C. Dixon, New York, NY (US); Kevin Caffrey, New York, NY (US)

(21) Appl. No.: 15/007,627

(22) Filed: Jan. 27, 2016

Related U.S. Application Data
(60) Provisional application No. 62/109,201, filed on Jan. 29, 2015.

(51) Int. Cl. G06Q 30/02; H04L 29/08

(52) U.S. Cl. CPC G06Q 30/0236; H04L 67/34

(57) ABSTRACT

A server may receive, from a software development kit (SDK) installed in an application executed by a processor of a mobile device, a first identifier identifying a service associated with a beacon device. The server may receive from the SDK one or more identifiers associated with the physical location of the beacon device. The server may select an alert to transmit to the application of the mobile device comprising an in-application reward for performing an in-application service in view of the first identifier and the one or more identifiers. The server may transmit the alert to the application of the mobile device.

### CROSS-REFERENCE TO RELATED APPLICATIONS

This application claims the benefit of U.S. provisional patent application No. 62/109,201 filed Jan. 29, 2015, the disclosure of which is incorporated herein by reference in its entirety.

### TECHNICAL FIELD

Examples of the present disclosure relate to a method and system to permit a business with physical locations to connect with their customers on their mobile devices.

### BACKGROUND

iBeacon technology built into iOS devices permits applications (hereinafter “apps”) running on mobile devices (e.g., an iPhone) to register to be notified and to perform actions when they are in the vicinity of compatible beacon devices (e.g., an “iBeacon”).

These beacon devices may be Bluetooth Low Energy (BLE) devices that advertise their presence according to the BLE standard. In non-beacon applications of BLE, these advertisements are used, e.g., by a smart watch device or a heart rate monitor device to notify a smartphone that the smart watch device or a heart rate monitor device is present and is ready to provide services. With iBeacon devices, however, the beacon devices are BLE devices that advertise their presence but are not configured to perform other functions. The advertisement is meant only to indicate that the iBeacon is present.

This is useful only if the advertisement also indicates something about which particular beacon is present. When a BLE device advertises its presence, the BLE device may transmit 31 bytes of arbitrary data that is available to devices that receive the advertisement. The iBeacon standard specifies that part of this to be used by the iBeacon to transmit three IDs to identify itself. These IDs include:
A UUID (universally unique identifier), a 128-bit value that identifies one or more beacons as being of a certain type or from a certain organization;
a major value, which is a 16-bit integer that distinguishes between beacons with the same UUID; and
a minor value, which is a 16-bit integer that distinguishes between beacons with the same UUID and major value.

In the iOS platform employed by iPhones and iPads, there is corresponding functionality that permits apps running on the iPhones and iPads to register to be notified when the iPhones and iPads enters beacon regions, defined as being near a beacon either with (i) a given UUID, (ii) a given UUID and major value, or (iii) a given UUID, major value, and minor value.

Apps register with iOS to monitor beacon regions using UUIDs, major values, and minor values that have been coordinated in advance. For example, a department store of a business may use the same UUID for all of its beacons. The business may use a different major value for each of its stores and a different minor value for each of its departments. Knowing these values, the department store's app understands the meaning of the beacons the app sees.

When an app is being used in the foreground and is notified about entering a beacon region, the app may perform anything in response. In a typical application, a user may have a store's app open to navigate around and learn about the store, and the app may tell the user which part of the store the user is in and what specials are available there.

If an app is running in the background and is notified about a beacon, the app is given a short amount of time to run code. Typically, the app uses this time to send an alert to the user or record that the user was near the beacon.

The main intention of iBeacon technology is for retail stores or other venues to enhance their own apps with information relevant to the consumer's exact location within that venue.

For example, baseball stadiums have installed beacons near the turnstiles, and if a consumer opens the MLB app when near the turnstile, the consumer's ticket is automatically displayed. Once the consumer is in the stadium, the user may receive specials on food when the consumer approaches certain concession stands or when the consumer needs to obtain directions toward their seats.

Consumers who have the app for a retail location may receive an alert welcoming them, and if they open the app, they may see a welcome message with current specials. If they approach certain areas of the store, they may see sales or offers relevant to that area. Apps frequently provide more information about products that the consumer is near. For example, in the section of an electronics store where a certain type of product is featured, the app may surface information about that product.

Even before iBeacon technology was introduced, apps employing the iOS platform have been able to register to be notified when the a mobile device is in a specific geographic region using functionality called geofencing. For example, a to-do list app may alert a user to pick up milk when the mobile device are near the grocery store. This technology is based on the positioning functionality built in to iOS, which relies on a combination of GPS and WiFi signals to establish the user's location.

The process for an app to register for geofencing and the results when the user enters a registered region are similar to those used to register and respond to iBeacons as described above. The difference is that the app specifies a geographic region rather than beacon identifiers.

Because geofencing relies on the positioning features of the device, geofencing is subject to accuracy limitations not present with iBeacons. A mobile device encountering an iBeacon will consistently detect the IBeacon. False positives and failure to detect a beacon are unlikely. Geofencing, on the other hand, is subject to a more error, especially in urban environments and indoors. A mobile device tracking whether a user of the mobile device is in a certain location may think the mobile device is in that location when it is not, or may fail to register when the mobile device is present in that location.

For detecting that a mobile device is roughly in a given area, geofencing functionality is adequate. However, for detecting that the mobile device is in one a specific store rather than the one next door or that the mobile device is in a certain department rather than another, geofencing is inadequate.

The general approach of using advertisements from Bluetooth LE devices to monitor for location was introduced by Apple with iBeacon. Apple created specific support for this approach in iOS. However, this approach can be implemented on any device that has a Bluetooth LE radio if the software has adequate access to the device.

On iOS devices, it is not possible in general to listen for Bluetooth devices in the background. The specific functionality for listening for beacons, based on the iBeacon standard, was built into iOS and is restricted to the functions described above.

On Android and other smartphone platforms, developers do not have the option of asking the operating system to notify them when they encounter specific beacons. However, Android and other smartphone platforms are given much more flexibility to make use of a Bluetooth radio when writing software. For that reason, the same effects may be achieved on Android and other platforms as may be with iOS by having an app run in the background and occasionally check for the presence of target beacons. This presents challenges related to preserving battery life, not slowing down the device, etc.

### SUMMARY

The above-described problems are remedied and a technical solution is achieved in the art by providing a method of operating a server. A server may receive, from a software development kit (SDK) installed in an application executed by a processor of a mobile device, a first identifier identifying a service associated with a beacon device. The server may receive from the SDK one or more identifiers associated with the physical location of the beacon device. The server may select an alert to transmit to the application of the mobile device comprising an in-application reward for performing an in-application service in view of the first identifier and the one or more identifiers. The server may transmit the alert to the application of the mobile device. Selecting the application to transmit the alert may be based on at least one of cost of the application, volume maximums associated with the application, and which applications the user (e.g., a consumer associated with the mobile device) uses most frequently.

The alert may be, for example, a text alert to be transmitted to the user by the application. The text alert may be based on at least one of the name of an entity (e.g., a local business) associated with the in-application service, the configuration of the in-application service, or what the user (e.g., the consumer) associated with the mobile device will receive as a reward for completing the in-application service.

The server may receive from the application an indication that the in-application service was performed.

The above-described problems are remedied and a technical solution is achieved in the art by providing a method of operating an SDK installed in an application executed by a processor of a mobile device. The software development kit (SDK) installed in an application executed by a processor of a mobile device (e.g., an iPhone, Android phone, etc.), may receive a first identifier transmitted by a beacon device, the first identifier identifying a service associated with the beacon device. The SDK may determine one or more identifiers associated with the physical location of the beacon device. The SDK may report to a server the first identifier and the one or more identifiers. The SDK may receive from the server an alert to transmit to the application of the mobile device, the alert comprising a reward for performing an in-application service in view of the first identifier and the one or more identifiers. The SDK may receive from the application of the mobile device an indication that the in-application service was performed. The SDK may transmit the indication to the server.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 is a block diagram of an example system in which examples of the present disclosure may operate.

FIG. 2 is a flow diagram illustrating an example of a method to operate a ReTap server.

FIG. 3 is a flow diagram illustrating an example of a method to operate a ReTap software development kit (SDK) installed in an application executed by a processor of a mobile device.

FIG. 4 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION

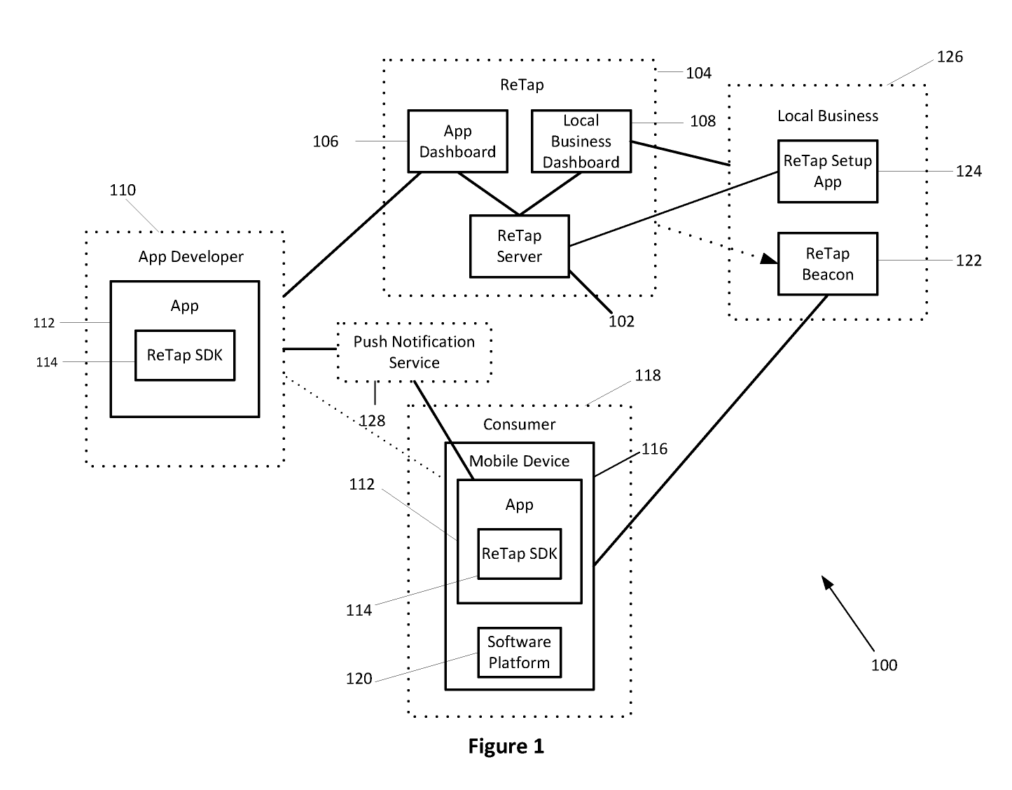

FIG. 1 is a block diagram of a system 100 in which examples of the present disclosure may operate. The system 100 includes a server 102 (hereinafter “the ReTap server 102”) as part of a hardware/software platform (hereinafter “ReTap 104”) configured to implement an application dashboard 106 and a local business dashboard 108. The application dashboard 106 permits application developers 110 to configure how their application(s) 112 employing the SDK is to be monetized and to view statistics concerning the application(s) 112 that the application developer 110 may develop using a software development kit (SDK) 114 (hereinafter “the ReTap SDK 114”) provided by the ReTap platform 104. The ReTap SDK 114 may be downloaded and installed in the application(s) 112 on a mobile device 116 (e.g., an iPhone, an Android phone, etc.) by a user (e.g., a consumer 118) of the mobile device 116. The application(s) 112 employing the ReTap SDK 114 may be configured to run on a mobile software platform 120 (e.g., iOS, Android, etc.) executed by a processing device (not shown) within the mobile device 116.

The local business dashboard 108 permits an entity (e.g., a local business 126) to configure a beacon device 122 (hereinafter “a ReTap beacon device 122”) provided by the ReTap platform 104 using a ReTap setup application 124, to place the ReTap beacon 122 in a location of the local business 126, and to view statistics concerning the usage of the ReTap beacon 122 by the applications 112 that detect the presence of and take actions in response to the user (e.g., a consumer 118) of the mobile device 116 entering or exiting the vicinity of the ReTap beacon device 122.

The application developers 110 normally receives compensation for their apps 112 in three different ways:
Purchase cost—Users 118 pay a certain amount to buy the app 112 and may download the app 112 and use the app 112.
IAP—The apps 112 offer in-app purchases (or “IAP”). These are purchases that the user 118 can make within the app 112 that unlock additional features, provide the users 118 with an in-app currency of value (such as coins or gems in a game), or provide subscription-based access to the app 112.
Advertisements—In addition, app developers 110 frequently monetize their apps 112 by showing ads. The developer 110 arranges with an ad network to show ads to users 118 at certain places within their app 112. The ad networks select ads to show to the user 118 and then pay the app developer 110 based either on how many ads were shown or on the clicks or actions that the ads caused.

One consideration with respect to the effectiveness of ads is how long they capture the attention of the user 118, e.g., does the user 118 see a small ad on the bottom of the screen or watch a long video? The latter is of much more value to the advertiser but is much more of an imposition to the user 118. Realizing this, app developers 112 reach some equilibrium in this regard meant by maximizing ad revenue while minimizing user irritation that would result in the user 118 using the app 110 less frequently or uninstalling the application 110.

For applications 110 with in-app purchases, there is another option, which is to give the user 118 an opportunity to watch and even interact with an ad for a long time (e.g., a 30-second video) in exchange for getting something that would otherwise cost them money via in-app purchases. Users 118 who do not wish to do this may dismiss the opportunity. Users 118 who choose to view the ad do so and then receive the in-app value for free, but the app 110 instead receives payment from the advertiser.

There are now mobile ad networks that application developers 112 may sign up to monetize their applications 110 in this way. Referring again to FIG. 1, the ReTap server 102 may be configured to receive from a ReTap SDK 114 installed in one or more applications 110 executed by a processor (not shown) of a mobile device 116, a first identifier transmitted by a ReTap beacon device 122. The first identifier (e.g., a UUID) may identify a service associated with the ReTap beacon device 122 (e.g., services provided by the ReTap platform 104, e.g., a beacon device for ReTap services). The ReTap server 102 may be configured to receive from the ReTap SDK 114, one or more identifiers (e.g., a major identifier and a minor identifier) associated with the physical location of the ReTap beacon device 122.

The ReTap server 102 may be configured to select an alert to transmit to the application 112 comprising an in-application reward for performing an in-application service in view of the first identifier and the one or more identifiers. The ReTap server 102 may be configured to transmit the alert to the application 112. The ReTap server 102 may be configured to receive from the application 112 an indication that the in-application service was performed.

The ReTap software development kit (SDK) 114 installed in an application 112 executed by a processor (not shown) of a mobile device 116 (e.g., an iPhone, Android phone, etc.) may be configured to receive a first identifier transmitted by a ReTap beacon device 112. The first identifier may identify a service (e.g., a ReTap) associated with the ReTap beacon device 112. The ReTap SDK 114 may be configured to determine one or more identifiers (e.g., a major identifier and a minor identifier) associated with the physical location of the ReTap beacon device 112. The Retap SDK 114 may be configured to report to the ReTap server 102 the first identifier and the one or more identifiers. The Retap SDK 114 may be configured to receive from the ReTap server 102 an alert to transmit to the application 112. The alert may comprise a reward for performing an in-application service in view of the first identifier and the one or more identifiers. The Retap SDK 114 may be configured to receive from the application 112 an indication that the in-application service was performed. The Retap SDK 114 may be configured to transmit the indication to the ReTap server 102.

ReTap is a product that permits anyone who runs a business with physical locations to connect with their customers on their mobile devices. Online advertisers have long been able to do this but it is more difficult for offline retailers.

Referring again to FIG. 1, an entity (e.g., a local business 126) may sign up for ReTap service with the ReTap platform 104. The ReTap platform 104 may provision a new ReTap beacon device 122 for the local business 126 by assigning to the ReTap beacon device 122 a proximity ID associated with all ReTap beacon devices 122 and a major and minor value associated with the location of a local business 126.

The platform 104 provides the local business 126 with the ReTap beacon device 122, and the local business 126 may place the ReTap beacon device 122 near the entrance to the store associated with the local business 126. The platform 104 may provide the local business 126 with a ReTap setup application 124, which the local business 126 installs and runs on an ordinary smartphone. The ReTap setup application 124 may listen for the ReTap beacon device 122 in order to confirm that the ReTap beacon device 122 has been installed and is transmitting properly. The ReTap setup application 124 may record the latitude and longitude of the store to obtain an approximate value of the location of where the ReTap beacon device 122 is installed. The ReTap setup application 124 may transmit a confirmation of proper operation of the ReTap beacon device 122 along with the measured latitude and longitude to the ReTap server 102, which stores that information in a database associated with the ReTap server 102 (not shown).

The local business 126 may log into the ReTap local business dashboard 108 implemented by the ReTap server 102. The local business 126 may enter ReTap local business dashboard 108 basic information about their business, e.g., the name and phone number of the local business 126. The local business 126 may configure what they want consumers 118 with ReTap apps 112 on their mobile devices 116 to do when the consumers 118 enter or exit the store. Choices may include, for example, viewing content (like specials), taking a photo, entering a testimonial, posting about the visit to a social network, making a phone call, or signing up for a newsletter. These choices are referred to as types of ReTaps. Depending on the type of ReTap selected, the local business 126 may also provide further configuration such as entering the specials that the local business 126 wants the user (e.g. the consumer 118) to view.

The local business 126 may configure a ReTap schedule that specifies how local business 126 wants to reconnect with the user (e.g. the consumer 118) after the user (e.g. the consumer 118) has visited the store. The local business 126 may specify one or more trigger times after the visit, e.g., one week after the visit. For each, the local business 126 may select and configure a ReTap just as they did when making choices about the initial visit.

An application developer 110 who wishes to monetize their application 112 may sign up with the ReTap platform 104. The application developer 110 may log into an application dashboard 106 and may enter the names and details of the application(s) 112 that the application developer 110 may want to monetize with the ReTap platform 104. For each application 112, the application developer 110 may enter how much the application developer 110 may want to be paid any time a ReTap alert is transmitted through the application 112. The application developer 110 may enter the names of one or more awards that are available in the application 112 (e.g., “coins”) and how much application developer 110 may wish to be paid for each award. The application developer 110 may enter how many coins the user (e.g. the consumer 118) should be awarded for successfully completing each type of ReTap. In another example, ReTap operators may enter this information for the apps 112 based on pre-arranged business terms.

For each application 112, the application developer 110 may supply credentials that application developer 110 had previously registered with a push notification service 128. These credentials may be needed to permit the ReTap platform 104 to send alerts from the application 112 on behalf of the application developer 110.

The ReTap platform 104 may provide the application developer 110 with the ReTap SDK 124, which the application developer 110 installs in their applications 112. The application developer 110 may determine that the installation was performed successfully using tools provided by the ReTap platform 104. The application developer 110 may submit their updated applications 112 to an app store.

A user (e.g., the consumer 118) may download the application 112 having the ReTap SDK 114 incorporated therein and install the application 112 on their mobile devices 116 (e.g., iPhone, Android phone). When the user (e.g., the consumer 118) runs the application 112 for the first time, the ReTap SDK 114 that is installed in the application 112 ensures that the user (e.g., consumer 118) has given the application 112 permissions needed for the ReTap SDK to perform its functions, including permission to monitor location in the background and to send alerts. The ReTap SDK 114 that is installed in the application 112 may then register with the software platform 120 to listen for any ReTap beacon devices 122 with the proximity UUID (e.g., a first identifier) used by the ReTap platform 104. The ReTap SDK 114 may report to the ReTap server 102 that the application 112 was installed, supplying an IDFA (ID for advertisers), an identifier that can be used to identify the particular smartphone on which the application 112 is installed. The ReTap server 102 may record this information in a database associated with the ReTap server 102 (not shown).

The user (e.g., the consumer 118) may enter a location (e.g., a store) associated with the local business 126. The ReTap beacon device 122 may transmit the UUID that the software platform 120 is listening for, so the software platform 120 awakens the application 112 residing on the mobile device 116 and notifies the ReTap SDK 114 that the mobile device 116 is near the ReTap beacon device 122. The ReTap SDK 114 briefly ranges for ReTap beacon devices 122, which permits the ReTap SDK 114 to determine the major and minor values (e.g., a second identifier and a third identifier) of the specific ReTap beacon device 122 that the ReTap SDK 114 has encountered. The ReTap SDK 114 may report to the ReTap server 102 that ReTap SDK 114 has encountered a ReTap beacon device 122 with the detected major and minor values. (If multiple apps 112 with the ReTap SDK 114 are on the mobile device 116, all of the applications 112 may perform the same steps). The ReTap server 102 may record this information in a database (not shown) associated with the ReTap server 102. The ReTap SDK 114 may wait for instructions from the ReTap server 102.

If the local business 126 has not chosen to send an in-application ReTap service request to users (e.g., the consumers 118) when the user (e.g., the consumer 118) enter the store, then ReTap server 102 may only record the information and may tell each ReTap SDK 114 not to perform any actions. If the local business 126 has chosen an in-application ReTap service request to send, the ReTap server 102 may wait for requests from all of the applications 112 with the ReTap SDK 114 running on the same mobile device 116 (as identified by the IDFA) that recently entered the store, and now needs to select which application 112 should be used to deliver the in-application ReTap service request. Based on a combination of factors including cost, volume maximums, which applications 112 that particular consumer 118 uses most frequently, etc., the ReTap server 102 may select which application 112 may perform the in-application ReTap service and may tell the other applications 112 not to perform any actions.

The ReTap server 102 may assemble a text alert that may be transmitted to the user (e.g., the consumer 118) by the application 112 running on the mobile device 116 associated with the user (e.g., the consumer 118). The content of the assembled text alert may be based, e.g., on the name of the local business 126, the ReTap service the user (e.g., the consumer 118) configured, and what the user (e.g., the consumer 118) will receive if the user (e.g., the consumer 118) completes the in-application ReTap service. For example, the alert may be, “Welcome to Fred Anderson Toyota! Take a photo in our dealership for 5 free coins!”

The ReTap server 102 may be configured to inform the ReTap SDK 114 residing on the selected application 112 on the mobile device 116 of the user (e.g., the consumer 118) to send an alert with that text and the ReTap SDK 114 may transmit the alert to the user (e.g. the consumer 118). The user (e.g., the consumer 118) may view the alert popping up on their mobile device 116.

If the user (e.g., the consumer 118) is interested in the in-application ReTap service request, the user (e.g., the consumer 118) may tap on the alert, which opens the application 112. The ReTap SDK 114 may contact the ReTap server 102, which may return content to show the user (e.g., the consumer 118) along with the type and quantity of reward the consumer may receive if they complete the in-application ReTap service. For example, the ReTap server 102 may return content containing instructions to the user (e.g., the consumer 118) to take a photo in exchange for 5 free coins.

The user (e.g., the consumer 118) may chooses to take a photo to obtain the coins. The photo functionality on the mobile device 116 may be activated and the user (e.g., the consumer 118) may take a photo in the dealership. The ReTap SDK 114 may transmit this photo to the ReTap server 102, which stores the photo. The ReTap server 102 may call into the application 112 and may inform the application 112 to award the user (e.g., the consumer 118) the reward of the correct quantity and type. The application 112 may provide the user (e.g., the consumer 118) with this reward and the user (e.g., the consumer 118) may continues using the application 112.

When the user (e.g., the consumer 118) with the mobile device 116 leaves the region of the store, the application 112 may report that the mobile device 116 has left the region of the store to the ReTap server 102. If the local business 126 has not chosen to send an in-application ReTap service request to the users 118 when they leave the store, the ReTap server 102 may record the information and may inform the ReTap SDK 114 to perform no actions.

If the local business 126 has configured an in-application ReTap service request applicable to when the user (e.g., the consumer 118) leaves the store, the ReTap server 102 may perform the same procedure described hereinabove for when the user (e.g., the consumer 118) enters the store. The ReTap server 102 may select the in-application ReTap service request to deliver and the user (e.g., the consumer 118) may complete the in-application ReTap service in the same way as described hereinabove with respect to the user (e.g., the consumer 118) entering the store.

If the local business 126 has configured scheduled in-application ReTap service requests to be sent to user (e.g., the consumer 118) at some time after a visit to the store, then when the scheduled time arrives, the ReTap server 102 may perform the same procedure described hereinabove for when the user (e.g., the consumer 118) enters the store for selecting the in-application ReTap service request to deliver to the user (e.g., the consumer 118). Accordingly, different in-application ReTap service requests may be configured when the scheduled time arrives than on entry to the store. For example, “Welcome to Fred Anderson Toyota! Take a picture in the dealership for 5 free coins!” makes no sense if the consumer's visit to the store is long since completed. A more likely case would be, “Thanks for your recent visit to Fred Anderson Toyota! Fill out a survey for 5 free coins!”

This time, since the application 112 is not running, the ReTap server 102 may transmit the assembled alert text to the user (e.g., the consumer 118) via the push notification service 128. Although the mechanism is different, the alert appears the same to the user (e.g., the consumer 118) as described previously. If the user (e.g., the consumer 118) wishes to carry out the in-application ReTap service request, the user (e.g., the consumer 118) may do so in the same manner as described as when the the user (e.g., the consumer 118) completes the in-application ReTap service with respect to the user (e.g., the consumer 118) entering the store.

The local business 126 may log into the local business dashboard to view data about the number of in-application ReTap service request that were transmitted, the types, how many were completed, and data about how many of the consumers who saw or completed in-application ReTap services later visited the store again. In addition, the local business 126 may view the content that was generated by the completed in-application ReTap services. For example, the local business 126 may retrieve the testimonials and reviews supplied by consumers 118 in order to use them on their business web site, and the local business 126 may review survey results to improve their service.

In addition to this completed in-application ReTap services data, the local business 126 may view analytics about any of the visitors to their store who have applications 112 on the ReTap network, including how many consumers 118 came to their store, how long they stayed, and how frequently they came back. This data may be assembled from the data reported from the ReTap SDK 114 to the ReTap server 102, which is accumulated whether or not in-application ReTap service requests are shown.

The application developer 110 may log into the application dashboard 106 and may view analytics on how many in-application ReTap services alerts were sent through their applications 112, how many caused the user (e.g., the consumer 118) to open the application 112, and how many were completed. The application developer 110 may view data on the in-app rewards that have been granted and how much application developer 110 has earned.

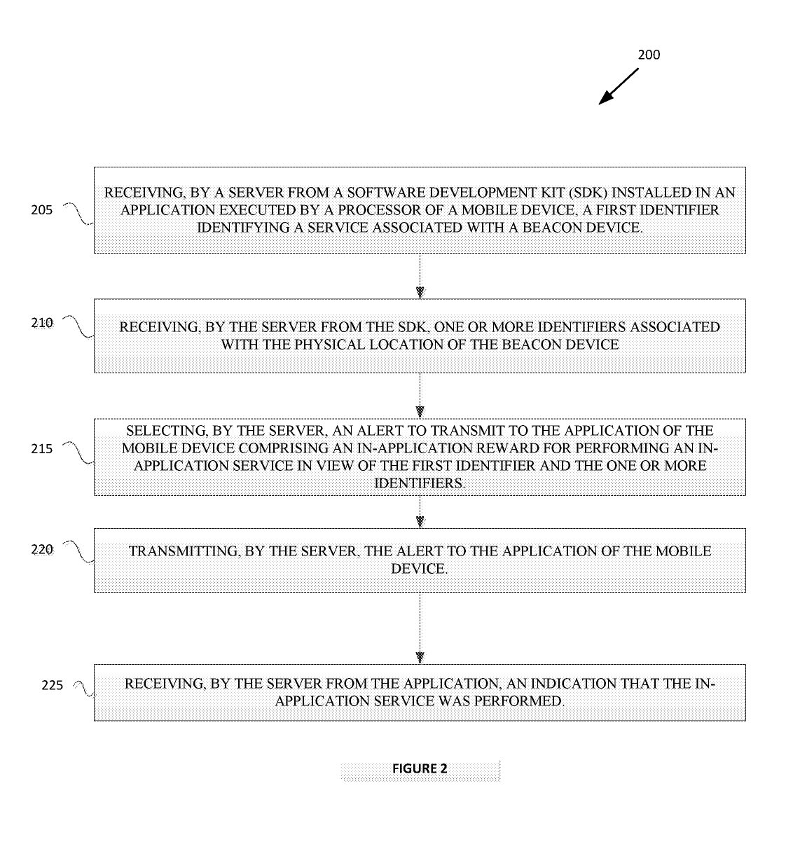

FIG. 2 is a flow diagram illustrating an example of a method 200 to operate a ReTap server 102. The method 200 may be performed by at least one processor of the ReTap server 102 of FIG. 1 and may comprise hardware (e.g., circuitry, dedicated logic, programmable logic, microcode, etc.), software (e.g., instructions run on a processing device), or a combination thereof. In one example, the method 200 is performed by server logic 422 of the at least one processor of the the ReTap server 102 of FIG. 1.

As shown in FIG. 2, at block 205, the ReTap server 102 may receive from a ReTap SDK 114 installed an application 110 executed by a processor (not shown) of a mobile device 116, a first identifier identifying a service associated with the ReTap beacon device 122 (e.g., services provided by the ReTap platform 104, e.g., a beacon device for ReTap services). At block 210, the ReTap server 102 may receive from the ReTap SDK 114, one or more identifiers (e.g., a major identifier and a minor identifier) associated with the physical location of the ReTap beacon device 122. At block 215, the ReTap server 102 may select an alert to transmit to the application comprising an in-application reward for performing an in-application service in view of the first identifier and the one or more identifiers. The ReTap server 102 may base selecting the alert to transmit based on at least one of cost of the application 112, volume maximums associated with the application 112, or which applications 112 the user (e.g., the consumer 118) uses most frequently.

At block 220, the ReTap server 102 may transmit the alert to the selected application 112. The alert may be, for example, a text alert to be transmitted to the consumer 118 by the application 112. In one example, ReTap server 102 may transmit an indication not to perform any actions to the remainder of the one or more applications 112. The text alert may be based on at least one of the name of an entity (e.g., the local business 126) associated with the in-application service, the configuration of the in-application service, or what the user (e.g., the consumer 118) associated with the mobile device 116 may receive as a reward for completing the in-application service.

At block 225, the ReTap server 102 may receive from the application 112 an indication that the in-application service was performed.

The ReTap server 102 may determine that the application 112 is from the mobile device 116. The ReTap server 102 may determine that the application 112 shares with the RETap server 102 the identifier for advertisers (IDFA) that identifies the particular mobile device 116 on which the application 112 is installed.

The ReTap server 102 may receive from the application 112 an indication that the user has tapped on the alert. The ReTap server 102 may transmit to the application 112 content to show to the user (e.g., the consumer 118) along with the type and quantity of reward the user (e.g., the consumer 118) associated with the mobile device 116 may receive for completing the in-application service.

The ReTap server 102 may receive from the application 112 a registering request to listen for the first identifier transmitted by the ReTap beacon device 122 responsive to the user (e.g., the consumer 118) of the application 112 receiving permissions to monitor the location of the mobile device 116 in the background and to transmit alerts to the user (e.g., the consumer 118).

The first identifier may be a proximity universal unique identifier (UUID). The one or more identifiers may be a major identifier and a minor identifier that identifies the physical location of the ReTap beacon device 122.

The alert may be specific to entering the range of the ReTap beacon device 122. The alert may be specific to exiting the range of the ReTap beacon device 122. The alert may be specific to a time period set to expire after the mobile device 116 enters or exits the range of the ReTap beacon device 122.

When the user (e.g., the consumer 118) completes the in-application service, the ReTap SDK 114 in the application 112 may credit the user (e.g., the consumer 118) with a type and quantity of a reward. The ReTap SDK 114 in the application 112 may transmit to the ReTap server 102 the type and quantity of a reward to be given to the user (e.g., the consumer 118) in an account of the user (e.g., the consumer 118).

The ReTap server 102 may receive from a setup application of a mobile device, an indication that the ReTap beacon device 122 has been installed and is working properly. The ReTap server 102 may receive from the setup application the latitude and longitude of the location where the beacon device is installed. The ReTap server 102 may store the indication and the latitude and longitude of the ReTap beacon device 122 in a database (not shown) associated with the ReTap server 102.

The ReTap server 102 may receive from a user (e.g. the consumer 118) associated with an entity (e.g., the local business 126) from a graphical user interface (e.g., the local business dashboard 108) implemented by the ReTap server 102, information related to the entity (e.g., the local business 126). The ReTap server 102 may receive one or more alerts to transmit to the application 112 when the mobile device 116 enters or exits the range of the ReTap beacon device 122 based on the information related to the entity (e.g., the local business 126). The ReTap server 102 may receive one or more alerts to transmit to the application 112 at a specified time after the mobile device 116 has exited the physical location associated with the ReTap beacon device 122. When the ReTap server 102 receives an indication from the mobile device 116 not to send an alert to the mobile device 116 when the mobile device 116 exits the vicinity of the ReTap beacon device 122, the ReTap server 102 may record in a database (not shown) associated with the ReTap server 102, the indication not to send an alert to the mobile device 116. The ReTap server 102 may transmit to the application 112 residing on the mobile device 116, an indication not to take an action when the mobile device 116 exits the vicinity of the ReTap beacon device 122.

After the mobile device 116 exits the vicinity of the ReTap beacon device 122, the ReTap server 102 may assemble a text alert and transmit the text alert to a push notification service 128.

The ReTap server 102 may receive in a graphical user interface (e.g., the local business dashboard 108) implemented by the ReTap server 102, a request for information with respect to the alerts transmitted to the application 112. The information may comprise at least one of the number of alerts that were transmitted, the types of alerts that were transmitted, the number of completed in-application services, or data indicating how many mobile devices that received alerts or completed in-application services later re-visited the vicinity of the ReTap beacon device 122. The information may comprise the content generated by the transmitted alerts. The generated content may comprise at least one of testimonials or review survey results provided by the user (e.g., the consumer 118) of the mobile device 116. The content may comprises how many users of the mobile devices entered the vicinity of the location of the ReTap beacon device 122, how long the users stayed, or how frequently the users returned to the location.

The ReTap server 102 may receive in a graphical user interface (e.g., the application dashboard 106) from a developer 110 of the selected application 112, the name and detail of the application 112 for the purpose of monetizing the application 112. Monetizing the application 112 may comprise at least one of: how much the developer 110 desired to be paid any time an alert is transmitted to the selected application 112, the names of one or more awards that are available in the in-application service, or how much the developer 110 wishes to be paid for successful completion of each in-application service. In another example, monetizing the application may be based on pre-arranged business terms.

The ReTap server 102 may receive from a developer 110 of the in-application service, credentials previously registered with a push notification service 128 to permit the ReTap server 102 to send alerts from the application 112 on behalf of developer 110.

The ReTap server 102 may receive in a graphical user interface (e.g., the application dashboard 106) from the developer 110 of the application 112, a request for analytics concerning the selected application 112. The analytics may comprise at least one of: how many alerts were transmitted through in-application services associated with the developer 110, how many alerts caused users of mobile devices to open the in-application service, how many in-application services were completed, data regarding the in-application rewards that have been granted, or how much money the developer 110 has earned.

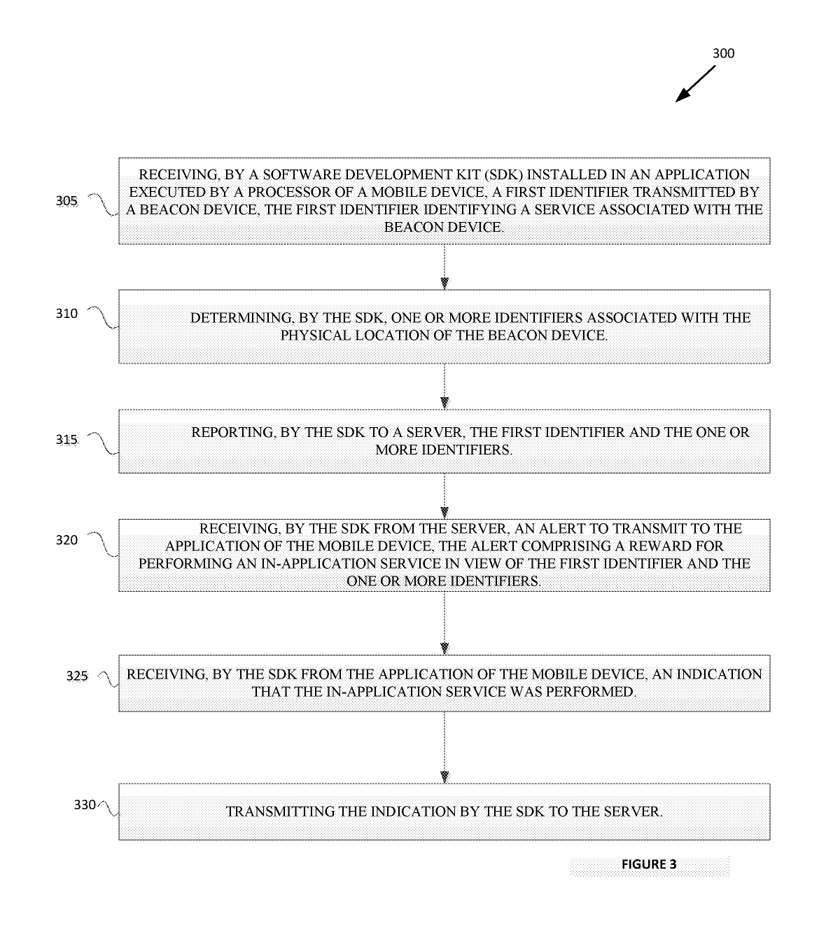

FIG. 3 is a flow diagram illustrating an example of a method 300 to operate a ReTap SDK 114 installed in an application 112 executed by a processor (not shown) of a mobile device 116. The method 300 may be performed by at least one processor of the mobile device 116 of FIG. 1 and may comprise hardware (e.g., circuitry, dedicated logic, programmable logic, microcode, etc.), software (e.g., instructions run on a processing device), or a combination thereof. In one example, the method 300 is performed by device logic 422 of the processor of the mobile device 116 of FIG. 1.

As shown in FIG. 3, at block 305, the ReTap software development kit (SDK) 114 installed in an application 112 executed by a processor (not shown) of a mobile device 116 (e.g., an iPhone, Android phone, etc.) may receive a first identifier transmitted by a ReTap beacon device 112. The first may identifier identify a service (e.g., ReTap) associated with the ReTap beacon device 112. At block 310, the Retap SDK 114 may determine one or more identifiers (e.g., a major identifier and a minor identifier) associated with the physical location of the ReTap beacon device 112. At block 315, the Retap SDK 114 may report to the ReTap server 102 the first identifier and the one or more identifiers. At block 320, the ReTap SDK 114 may receive from the ReTap server 102 an alert to transmit to the application 112 in view of the first identifier and the one or more identifiers. The alert may comprise a reward for performing an in-application service. At block 325, the ReTap SDK 114 may receive from the application 112 an indication that the in-application service was performed. At block 330, the ReTap SDK 114 may transmit the indication to the ReTap server 102.

The alert may be a text alert to be viewed by a user (e.g. the consumer 118) associated with the mobile device 116. The text alert may be based on at least one of the name of an entity (e.g., the local business 126) associated with the in-application service, the configuration of the in-application service, or what the user (e.g., the consumer 118) associated with the mobile device 116 will receive as a reward for completing the in-application service.

When the user (e.g., the consumer 118) of the mobile device 116 taps on the alert, a processor (not shown) residing on the mobile device 116 may open the application 112. A ReTap software development kit (SDK) 114 implemented by the application 112 may cause the application 112 to contact the ReTap server 102 with an indication that the user (e.g., the consumer 118) has tapped on the alert. The ReTap SDK 114 may receive content to show the user (e.g., the consumer 118) along with the type and quantity of reward the user (e.g., the consumer 118) may receive for completing the in-application service. In an example, the ReTap SDK 114 may receive from user (e.g., the consumer 118) of the application 112, permissions to monitor the location of the mobile device 116 in the background and to transmit alerts to the user (e.g., the consumer 118). In an example, responsive to receiving the permissions, the ReTap SDK 114 may register with the ReTap server platform 104 to listen for the first identifier transmitted by the ReTap beacon device 122.

The first identifier may be a proximity universal unique identifier (UUID). The one or more identifiers associated with the physical location of the ReTap beacon device 122 may be a major identifier and a minor identifier that identifies the location of the entity (e.g., the local business 126).

The ReTap SDK 114 may report to the ReTap server 102 an indication that the application 112 with the ReTap SDK 114 was installed on the mobile device 116. The ReTap SDK 114 may report to the ReTap server 102, an identifier for advertisers that identifies the particular mobile device 116 on which the application 112 is installed.

The ReTap SDK 114 may receive from the application 112 an indication that the application 112 has awakened in the foreground.

The ReTap SDK 114 may receive from the application 112, an indication that the mobile device 116 is within range of the ReTap beacon device 122.

The alert may be specific to the mobile device 116 entering the range of the ReTap beacon device 122. The alert may be specific to the mobile device 116 exiting the range of the ReTap beacon device 122. The alert may be specific to a time period set to expire after the mobile device 116 enters or exits the range of the ReTap beacon device 122.

Responsive to the user (e.g., the consumer 118) completing the in-application service, the ReTap SDK 114 in the application 112 may credit the user (e.g., the consumer 118) with a type and quantity of a reward and transmit to the ReTap server 102, the type and quantity of a reward to an account of the user (e.g., the consumer 118).

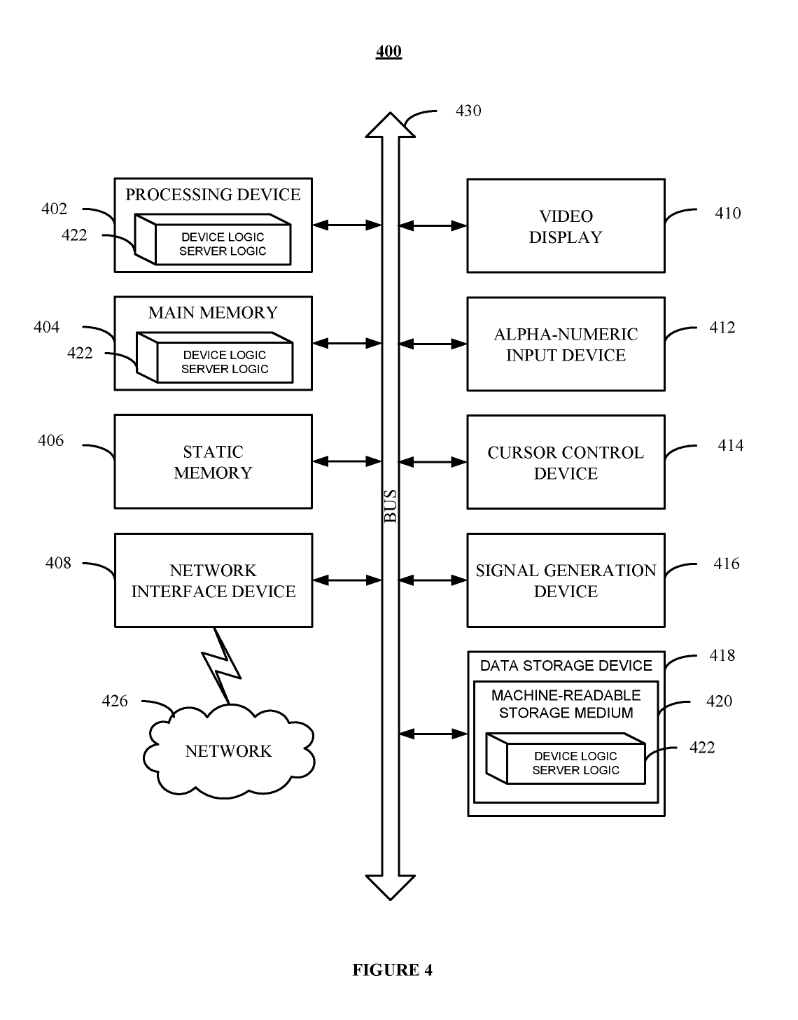

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) (such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute device logic or server logic 422 for performing the operations and steps discussed herein.

Computer system 400 may further include a network interface device 408. Computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

Data storage device 418 may include a machine-readable storage medium (or more specifically a computer-readable storage medium) 420 having one or more sets of instructions embodying any one or more of the methodologies of functions described herein. Device logic or server logic 422 may also reside, completely or at least partially, within main memory 404 and/or within processing device 402 during execution thereof by computer system 400; main memory 404 and processing device 202 also constituting machine-readable storage media. Device logic or server logic 422 may further be transmitted or received over a network 426 via network interface device 408.

Machine-readable storage medium 420 may also be used to store the device queue manager logic persistently. While machine-readable storage medium 420 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
receiving, by a server from a software development kit (SDK) installed in an application executed by a processor of a mobile device, a first identifier identifying a service associated with a beacon device;
receiving, by the server from the SDK, one or more identifiers associated with the physical location of the beacon device;
selecting, by the server, an alert to transmit to the application of the mobile device comprising an in-application reward for performing an in-application service in view of the first identifier and the one or more identifiers; and
transmitting, by the server, the alert to the application of the mobile device.

2. The method of claim 1, further comprising:
receiving, by the server from the application, an indication that the user associated with the mobile device has tapped on the alert; and
transmitting, by the server to the application, content to show to the user along with the type and quantity of reward the user associated with the mobile device receives for completing the in-application service.

3. The method of claim 1, further comprising:
receiving, by the server from the application, a registering request to listen for the first identifier transmitted by the beacon device responsive to the user of the selected application receiving permissions to monitor the location of the mobile device in the background and to transmit alerts to the user.

4. The method of claim 1, wherein the alert is specific to the mobile device entering the range of the beacon device.

5. The method of claim 1, wherein the alert is specific to the mobile device exiting the range of the beacon device.

6. The method of claim 1, wherein the alert is specific to a time period set to expire after the mobile device enters or exits the range of the beacon device.

7. The method of claim 1, wherein:
responsive to the user associated with the mobile device completing the in-application service,
crediting, by the SDK in the application, the user with a type and quantity of a reward; and
transmitting, by the SDK in the application to the server, the type and quantity of a reward to be given to the user in an account of the user.

8. The method of claim 1, further comprising:
receiving, by the server, one or more alerts to transmit to the application when the mobile device enters or exits the range of the beacon device based on the information related to an entity.

9. The method of claim 1, further comprising:
receiving, by the server, one or more alerts to transmit to the application at a specified time after the mobile device has exited the physical location associated with the beacon device.

10. The method of claim 1, further comprising:
receiving, by the server in a graphical user interface from a developer of the application, the name and detail of the selected application for the purpose of monetizing the application.

11. The method of claim 10, wherein monetizing the application comprises at least one of:
how much the developer desired to be paid any time an alert is transmitted to the application, the names of one or more awards that are available in the in-application service, or how much the developer wishes to be paid for successful completion of each in-application service.

12. The method of claim 1, further comprising determining, by the server, that the application is from the same mobile device.

13. The method of claim 1, further comprising determining that the application shares with the server an identifier for advertisers (IDFA) that identifies the particular mobile device on which the application is installed.

14. The method of claim 1, wherein selecting is based on at least one of cost of an application, volume maximums associated with an application, and which applications a user associated with the mobile device uses most frequently.

15. A system, comprising:
a memory;
a processor, operatively coupled to the memory, the processor to;
receive, from a software development kit (SDK) installed in an application executed by a processor of a mobile device, a first identifier identifying a service associated with a beacon device;
receive, from the SDK, one or more identifiers associated with the physical location of the beacon device;
select an alert to transmit to the application of the mobile device comprising an in-application reward for performing an in-application service in view of the first identifier and the one or more identifiers; and
transmit the alert to the application of the mobile device.

16. The system of claim 15, wherein the processor is further to:
receive, from the application, an indication that the user associated with the mobile device has tapped on the alert; and
transmit, to the application, content to show to the user along with the type and quantity of reward the user associated with the mobile device receives for completing the in-application service.

17. A method, comprising:
receiving, by a software development kit (SDK) installed in an application executed by a processor of a mobile device, a first identifier transmitted by a beacon device, the first identifier identifying a service associated with the beacon device;
determining, by the SDK, one or more identifiers associated with the physical location of the beacon device;
reporting, by the SDK to a server, the first identifier and the one or more identifiers;
receiving, by the SDK from the server, an alert to transmit to the application of the mobile device, the alert comprising a reward for performing an in-application service in view of the first identifier and the one or more identifiers;
receiving, by the SDK from the application of the mobile device, an indication that the in-application service was performed; and
transmitting the indication by the SDK to the server.

18. The method of claim 17, further comprising:
receiving, by the SDK from the application, an indication that the mobile device is within range of the beacon device.

19. The method of claim 17, wherein the alert is specific to the mobile device entering the range of the beacon device.

20. The method of claim 17, wherein the alert is specific to the mobile device exiting the range of the beacon device.

21. The method of claim 17, wherein the alert is specific to a time period set to expire after the mobile device enters or exits the range of the beacon device.

22. The method of claim 17, wherein:
responsive the user completing the in-application service,
crediting, by the SDK in the application, the user with a type and quantity of a reward; and
transmitting, by the SDK in the application to the server, the type and quantity of a reward to an account of the user.

23. The method of claim 17, wherein the alert is based on at least one of the name of an entity associated with the in-application service, a configuration of the in-application service, or what the user associated with the mobile device receives as a reward for completing the in-application service.

24. The method of claim 17, further comprising:
responsive to receiving a tap on the alert on the mobile device,
opening, by the processor, the application;
contacting the server by the SDK with an indication that the user has tapped on the alert; and
receiving, by the SDK, content to show the user along with the type and quantity of reward the user receives for completing the in-application service.

25. The method of claim 1, further comprising:
receiving, by the SDK from user of the application, permissions to monitor the location of the mobile device in the background and to transmit alerts to the user.

26. The method of claim 25, further comprising:
responsive to receiving permissions,
registering, with a server platform to listen for the first identifier transmitted by the beacon device.

27. The method of claim 17, further comprising:
reporting, by the SDK to the server, an indication that the application with the SDK was installed on the mobile device; and
reporting, by the SDK to the server, an identifier for advertisers that identifies the particular mobile device on which the application is installed.

28. The method of claim 17, further comprising:
receiving, by the SDK from the application, an indication that the application has awakened in the foreground.

29. A non-transitory computer-readable medium storing instructions that when executed by a software development kit (SDK) installed in an application executed by the processor of a mobile device, cause the processor to:
receive a first identifier transmitted by a beacon device, the first identifier identifying a service associated with the beacon device;
determine one or more identifiers associated with the physical location of the beacon device;
report to a server, the first identifier and the one or more identifiers;
receive, from the server, an alert to transmit to the application of the mobile device, the alert comprising a reward for performing an in-application service in view of the first identifier and the one or more identifiers;
receive, from the application of the mobile device, an indication that the in-application service was performed; and
transmit the indication by the SDK to the server.

30. The non-transitory computer-readable medium of claim 29, wherein the processor is further to:
responsive to receiving a tap on the alert on the mobile device,
open the application;
contact the server with an indication that the user has tapped on the alert; and
receive content to show the user along with the type and quantity of reward the user receives for completing the in-application service.
